(19) United States
(12) Patent Application Publication
(10) Pub. No.: US 2004/0218956 A1
(43) Pub. Date: Nov. 4, 2004

(54) Item processing system and method

(75) Inventor: Keith McMurray Boden, Reigate (GB)

Correspondence Address: Shoemaker and Mattare, Ltd., 2001 Jefferson Davis Highway, Arlington, VA, 22202, US

(73) Assignee: Neopost Industrie SA, Bagneux (FR)

(21) Appl. No.: 10/768,734

(22) Filed: Feb. 2, 2004

(30) Foreign Application Priority Data
Jan. 31, 2003 (GB) 0302269.6

(51) Int. Cl. B41J 5/30

(52) U.S. Cl. 400/70

(57) ABSTRACT

An item processing system for and a method of processing items each having an indicium printed thereon, the system comprising: at least one item printing station for printing indicia on items, wherein the indicia are printed at least one of at one of a plurality of locations, with one of a plurality of footprints and in at least one of a plurality of inks as defined by a configuration signal; and at least one item handling station for handling items having indicia printed thereon by the at least one item printing station, wherein each item handling station is configured to inspect each item for at least one of an indicium in a field of defined location, an indicium of defined footprint and an indicium in at least one defined ink as defined by the configuration signal; wherein the configuration signal is changed at intervals such that at least one of the location, the footprint and the at least one ink of the indicia printed on items is changed at each interval and correspondingly at least one of the field of defined location, the defined footprint and the at least one defined ink is changed at each interval, whereby items not having the at least one of an indicium in the defined field, an indicium of defined footprint and an indicium in the at least one defined ink is identified.

### FIELD OF THE INVENTION

The present invention relates to an item processing system for and a method of processing items, in particular mail items, which each include a printed indicium thereon.

### BACKGROUND OF THE INVENTION

Currently, item processing systems, such as mail processing systems, utilize a printed indicium to authenticate the payment of a processing charge. As a means of security, the indicium, for example, a two-dimensional data matrix or barcode, is cryptographically encoded.

It is an aim of the present invention to provide an item processing system for and a method of processing items, in particular mail items, which provides for a means of security which is alternative or additional to the means of security as currently utilized.

### SUMMARY OF THE INVENTION

In one aspect the present invention provides an item processing system for processing items each having an indicium printed thereon, the system comprising: at least one item printing station for printing indicia on items, wherein the indicia are printed at least one of at one of a plurality of locations, with one of a plurality of footprints and in at least one of a plurality of inks as defined by a configuration signal; and at least one item handling station for handling items having indicia printed thereon by the at least one item printing station, wherein each item handling station is configured to inspect each item for at least one of an indicium in a field of defined location, an indicium of defined footprint and an indicium in at least one defined ink as defined by the configuration signal; wherein the configuration signal is changed at intervals such that at least one of the location, the footprint and the at least one ink of the indicia printed on items is changed at each interval and correspondingly at least one of the field of defined location, the defined footprint and the at least one defined ink is changed at each interval, whereby items not having the at least one of an indicium in the defined field, an indicium of defined footprint and an indicium in the at least one defined ink is identified.

Preferably, the system further comprises: a control unit in communication with the at least one item printing station and the at least one item handling station, and being operable to transmit configuration signals at intervals to the at least one item printing station and the at least one item handling station.

In one embodiment the at least one item printing station is configured to print indicia at a changed location at each interval, and the at least one item handling station is configured to inspect each item for an indicium in a field of the changed location at each interval.

In one embodiment the at least one item printing station is configured to print indicia with a changed footprint at each interval, and the at least one item handling station is configured to inspect each item for an indicium having the changed footprint at each interval.

In one embodiment the at least one item printing station is configured to print indicia in at least one changed ink at each interval, and the at least one item handling station is configured to inspect each item for an indicium in the changed ink at each interval.

In one embodiment the indicia each comprise a plurality of elements, ones of which are of different ink.

Preferably, the system comprises a plurality of item printing stations.

Preferably, the system comprises a plurality of item handling stations.

Preferably, the items comprise mail items, such as letters and parcels.

In another aspect the present invention provides an item printing station for printing indicia on items, wherein the indicia are printed at least one of at one of a plurality of locations, with one of a plurality of footprints and in at least one of a plurality of inks as defined by a configuration signal, and the configuration signal is changed at intervals such that at least one of the location, the footprint and the at least one ink of the indicia printed on items is changed at each interval.

In one embodiment the printing station is configured to print indicia at a changed location at each interval.

In one embodiment the printing station is configured to print indicia with a changed footprint at each interval.

In one embodiment the printing station is configured to print indicia in at least one changed ink at each interval.

In one embodiment the indicia each comprise a plurality of elements, ones of which are of different ink.

Preferably, the items comprise mail items, such as letters and parcels.

In a further aspect the present invention provides an item handling station for handling items having indicia printed thereon, wherein the handling station is configured to inspect each item for at least one of an indicium in a field at one of a plurality of locations, an indicium with one of a plurality of footprints and an indicium in at least one of a plurality of inks as defined by a configuration signal, where the configuration signal is changed at intervals such that at least one of the location of the field, the footprint and the at least one ink is changed at each interval, whereby items not having the at least one of an indicium in a field of defined location, an indicium with a defined footprint and an indicium in at least one defined ink as defined by the configuration signal at each interval is identified.

In one embodiment the handling station is configured to inspect each item for an indicium in a field of defined location at each interval.

In one embodiment the handling station is configured to inspect each item for an indicium of defined footprint at each interval.

In one embodiment the handling station is configured to inspect each item for an indicium in at least one defined ink at each interval.

In one embodiment the indicia each comprise a plurality of elements, ones of which are of different ink.

Preferably, the items comprise mail items, such as letters and parcels.

In yet another aspect the present invention provides a method of processing items each having an indicium printed thereon, the method comprising the steps of: printing indicia on items, wherein the indicia are printed at least one of at one of a plurality of locations, with one of a plurality of footprints and in at least one of a plurality of inks as defined by a configuration signal; and handling items having indicia printed thereon, wherein the item handling step comprises the step of: inspecting each item for at least one of an indicium in a field of defined location, an indicium of defined footprint and an indicium in at least one defined ink as defined by the configuration signal; wherein the configuration signal is changed at intervals such that at least one of the location, the footprint and the at least one ink of the indicia printed on items is changed at each interval and correspondingly at least one of the field of defined location, the defined footprint and the at least one defined ink is changed at each interval, whereby items not having the at least one of an indicium in the defined field, an indicium of defined footprint and an indicium in the at least one defined ink is identified.

In one embodiment the indicia printing step comprises the step of: printing indicia on items at a changed location at each interval; and the item handling step comprises the step of: inspecting each item for an indicium in a field of the changed location at each interval.

In one embodiment the indicia printing step comprises the step of: printing indicia on items with a changed footprint at each interval; and the item handling step comprises the step of: inspecting each item for an indicium having the changed footprint at each interval.

In one embodiment the indicia printing step comprises the step of: printing indicia on items in at least one changed ink at each interval; and the item handling step comprises the step of: inspecting each item for an indicium in the changed ink at each interval.

In one embodiment the indicia each comprise a plurality of elements, ones of which are of different ink.

Preferably, the item handling step is performed at at least one location separate to the indicia printing step.

Preferably, the indicia printing step is performed at a plurality of locations.

Preferably, the item handling step is performed at a plurality of locations.

Preferably, the items comprise mail items, such as letters and parcels.

In a still further aspect the present invention provides a method of printing indicia on items, comprising the steps of: printing indicia on items at least one of at one of a plurality of locations, with one of a plurality of footprints and in at least one of a plurality of inks as defined by a configuration signal; and changing the configuration signal at intervals such that at least one of the location, the footprint and the at least one ink of the indicia printed on items is changed at each interval.

In one embodiment the indicia printing step comprises the step of: printing indicia on items at a changed location at each interval.

In one embodiment the indicia printing step comprises the step of: printing indicia on items with a changed footprint at each interval.

In one embodiment the indicia printing step comprises the step of: printing indicia on items in at least one changed ink at each interval.

In one embodiment the indicia each comprise a plurality of elements, ones of which are of different ink.

Preferably, the indicia printing step is performed at a plurality of locations.

Preferably, the items comprise mail items, such as letters and parcels.

In still yet another aspect the present invention provides a method of handling items having indicia printed thereon, comprising the steps of: handling items having indicia printed thereon, wherein the item handling step comprises the step of: inspecting each item for at least one of an indicium in a field at one of a plurality of locations, an indicium with one of a plurality of footprints and an indicium in at least one of a plurality of inks as defined by a configuration signal; and changing the configuration signal at intervals such that at least one of the location of the field, the footprint and the at least one ink is changed at each interval, whereby items not having the at least one of an indicium in a field of defined location, an indicium with a defined footprint and an indicium in at least one defined ink as defined by the configuration signal at each interval is identified.

In one embodiment the item handling step comprises the step of: inspecting each item for an indicium in a field of defined location at each interval.

In one embodiment the item handling step comprises the step of: inspecting each item for an indicium of defined footprint at each interval.

In one embodiment the item handling step comprises the step of: inspecting each item for an indicium in at least one defined ink at each interval.

In one embodiment the indicia each comprise a plurality of elements, ones of which are of different ink.

Preferably, the item handling step is performed at a plurality of locations.

Preferably, the items comprise mail items, such as letters and parcels.

### BRIEF DESCRIPTION OF THE DRAWING

A preferred embodiment of the present invention will now be described hereinbelow by way of example only with reference to the accompanying drawing, in which:

FIG. 1 illustrates a mail processing system including mail printing stations and mail handling stations in accordance with a preferred embodiment of the present invention.

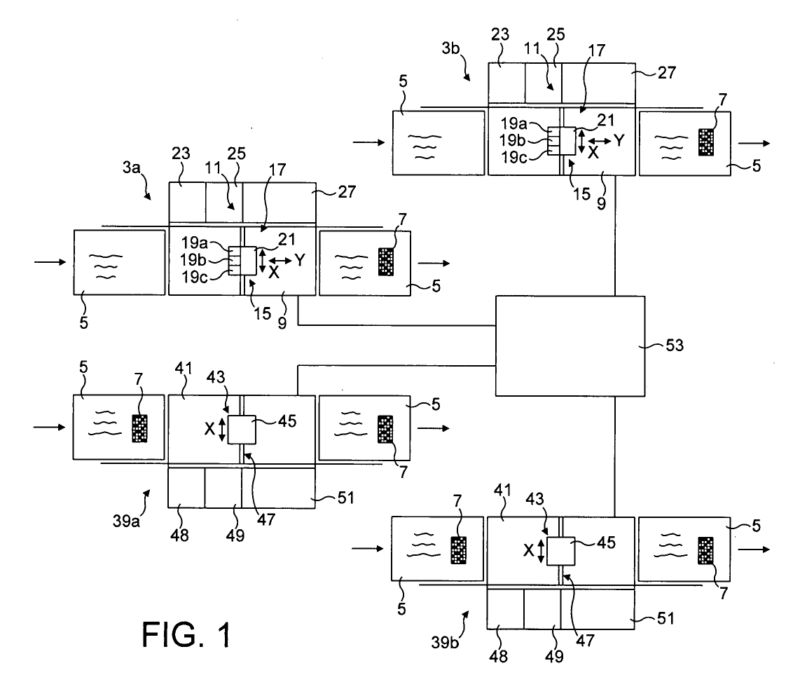

### DETAILED DESCRIPTION OF THE PREFERRED EMBODIMENT

The mail processing system comprises a plurality of mail printing stations 3a, 3b for printing mail items 5 with postage indicia 7 including postage information, such as postage value and addressee and sender details. In this embodiment the postage indicia 7 are two-dimensional data matrices, typically as specified by the IBIP standard. In a preferred embodiment the postage indicia 7 are cryptographically encoded, such as by encryption or digital signature. In an alternative embodiment the postage indicia 7 could comprise simple elements, for example, a block element which includes no intrinsic information.

The mail printing stations 3a, 3b each comprise a support platform 9 on which mail items 5 are printed, in this embodiment defining in part a mail transport path along which mail items 5 are transported, and a printing unit 11 for printing mail items 5 with postage indicia 7.

The printing unit 11 comprises a print head assembly 15 for printing mail items 5 with postage indicia 7, and a positioning mechanism 17 for positioning the print head assembly 15 relative to the support platform 9. In this embodiment the print head assembly 15 is movable in first and second orthogonal directions X, Y over the support platform 9 such as to allow the print head assembly 15 to be positioned at any location within a printing zone, and thereby enable a postage indicium 7 to be printed at any location on a mail item 5 within the printing zone. As will be described in more detail hereinbelow, the print head assembly 15 is configurable to print a postage indicium 7 at a predetermined location on a mail item 5, typically within a field which is a predetermined distance from one of the ends or sides thereof.

The print head assembly 15, in this embodiment an ink-jet print head assembly, includes a plurality of printing ink supplies 19a, 19b, 19c, each having a different characteristic, in this embodiment colour, and a print head 21 for delivering printing ink to print a postage indicium 7. In another embodiment the printing ink supplies 19a, 19b, 19c could be of different reflectance. In this embodiment the print head assembly 15 is operable to print postage indicia 7 with a selected one of the inks or with parts in different inks.

The mail printing stations 3a, 3b each further comprise a controller 23, in this embodiment a microprocessor-based controller, for controlling the printing unit 11 and performing accounting functions, and a user interface 25 for enabling user control of the respective mail printing station 3a, 3b.

The mail printing stations 3a, 3b each further comprise a communications unit 27 for providing for communication with a remote, control station 53, as will be described in more detail hereinbelow. The communications unit 27 provides inter alia for the periodic receipt of a configuration signal from the control station 53, which configuration signal configures the print head assembly 15 to print postage indicia 7 at a predetermined location and in one or more of the inks of the plurality of printing ink supplies 19a, 19b, 19c on mail items 5.

The mail processing system further comprises a plurality of mail handling stations 39a, 39b for handling mail items 5 including postage indicia 7 printed thereon by the mail printing stations 3a, 3b.

The mail handling stations 39a, 39b each comprise a transport platform 41 over which mail items 5 are transported, and an inspection unit 43 for inspecting the postage indicia 7 on mail items 5.

The inspection unit 43 comprises a reader 45, in this embodiment a camera, for inspecting the postage indicia 7 on mail items 5, and a positioning mechanism 47 for positioning the reader 45 relative to the transport platform 41.

In this embodiment the reader 45 is movable in a direction X orthogonal to the mail transport path such as to allow the reader 45 to be positioned at any location across the mail transport path, and thereby enable the reading of postage indicia 7 at any predetermined location on mail items 5 as transported over the mail transport platform 41. As will be described in more detail hereinbelow, with this configuration, the inspection unit 43 provides for the identification of mail items 5 which do not have postage indicia 7 thereon in one or both of an expected location and in an expected ink, for example, an ink of a predetermined colour or reflectance, and thus have been improperly printed.

The mail handling stations 39a, 39b each further comprise a controller 48, in this embodiment a microprocessor-based controller, for controlling the inspection unit 43, and a user interface 49 for enabling user control of the respective mail handling station 39a, 39b.

The mail handling stations 39a, 39b each further comprise a communications unit 51 for providing for communication with the control station 53, as will be described in more detail hereinbelow. The communications unit 51 provides inter alia for the periodic receipt of a configuration signal from the control station 53, which configuration signal configures the inspection unit 43 such that the reader 45 is positioned to inspect postage indicia 7 at a predetermined location on mail items 5.

The mail processing system further comprises a control station 53 which is remote from the mail printing stations 3a, 3b and the mail handling stations 39a, 39b and is in communication therewith through the respective communications units 27, 51 thereof. The control station 53 is configured at a configuration event to transmit a configuration signal to the mail printing stations 3a, 3b and the mail handling stations 39a, 39b such as to re-configure the printing units 11 of the mail printing stations 3a, 3b to print postage indicia 7 at one or both of a changed location and in a changed ink on mail items 5, and the inspection units 43 of the mail handling stations 39a, 39b to inspect postage indicia 7 on mail items 5 one or both of at a corresponding changed location as defined by the new configuration signal or for a transitional period the previously-defined configuration signal and in a changed ink defined by the new configuration signal or for a transitional period the previously-defined configuration signal. In one embodiment the mail printing stations 3a, 3b are re-configured such that all mail items 5 printed with postage indicia 7 for introduction into the mail stream after a predetermined time include postage indicia 7 in one or both of the changed location and the changed ink, and the mail handling stations 39a, 39b are re-configured such that all mail items 5 received after the predetermined time are inspected for postage indicia 7 at one or both of the changed location and in the changed ink.

In operation, the mail printing stations 3a, 3b are utilized to print postage indicia 7 on mail items 5, with the location of and the inks used to print the postage indicia 7 being defined by the current configuration signal, and the mail handling stations 39a, 39b, which handle the mail items 5 so printed by the mail printing stations 3a, 3b, inspect one or both of a predetermined location on the mail items 5 for postage indicia 7 and the ink of the postage indicia 7 on the mail items 5. In this embodiment, where the mail printing stations 3a, 3b and the mail handling stations 39a, 39b have been re-configured within a recent predetermined period, for example, a period of a number of days previously, the mail handling stations 39a, 39b are configured additionally to inspect one or both of another predetermined location on the mail items 5 for postage indicia 7 as defined by the previous configuration signal and the ink of the postage indicia 7 on the mail items 5 as defined by the previous configuration signal.

In inspecting mail items 5, the mail handling stations 39a, 39b identify any mail items 5 which do not include postage indicia 7 in one or both of the predetermined location defined by the current configuration signal, or the previous configuration signal where in a transitional period, and the ink defined by the current configuration signal, or the previous configuration signal where in a transitional period. Any mail items 5 which do not include postage indicia 7 in one or both of the expected location or the expected ink are diverted from the mail stream and checked further, as one or both of the incorrect location of the postage indicia 7 and the incorrect ink of the postage indicia 7 is indicative of the mail items 5 having postage indicia 7 fraudulently applied thereto.

As will be appreciated, the mail processing system of the present invention, in providing for security through an alterable physical characteristic, in this embodiment one or both of the location and ink, of the postage indicia 7 as applied to mail items 5, which can be altered at any interval, can provide for security absent the postage indicia 7 having any inherent security, such as provided when cryptographically encoded. Where the postage indicia 7 has inherent security, such as through being cryptographically encoded, the mail processing system of the present invention provides for an additional means of security.

Finally, it will be understood that the present invention has been described in its preferred embodiment and can be modified in many different ways without departing from the scope of the invention as defined by the appended claims.

In the described embodiment the postage indicia 7 as applied to mail items 5 have the same footprint. In one alternative embodiment the mail printing stations 3a, 3b are configured to provide for the printing of postage indicia 7 with different footprints, typically one or both of shape and size, as defined by a configuration signal, and the mail handling stations 39a, 39b are similarly configured to expect postage indicia 7 having the predetermined footprint as defined by the configuration signal, and identify any mail items 5 not having such postage indicia 7.

1. An item processing system for processing items each having an indicium printed thereon, the system comprising:
at least one item printing station for printing indicia on items, wherein the indicia are printed at least one of at one of a plurality of locations, with one of a plurality of footprints and in at least one of a plurality of inks as defined by a configuration signal; and
at least one item handling station for handling items having indicia printed thereon by the at least one item printing station, wherein each item handling station is configured to inspect each item for at least one of an indicium in a field of defined location, an indicium of defined footprint and an indicium in at least one defined ink as defined by the configuration signal;
wherein the configuration signal is changed at intervals such that at least one of the location, the footprint and the at least one ink of the indicia printed on items is changed at each interval and correspondingly at least one of the field of defined location, the defined footprint and the at least one defined ink is changed at each interval, whereby items not having the at least one of an indicium in the defined field, an indicium of defined footprint and an indicium in the at least one defined ink is identified.

2. The system of claim 1, further comprising:
a control unit in communication with the at least one item printing station and the at least one item handling station, and being operable to transmit configuration signals at intervals to the at least one item printing station and the at least one item handling station.

3. The system of claim 1, wherein the at least one item printing station is configured to print indicia at a changed location at each interval, and the at least one item handling station is configured to inspect each item for an indicium in a field of the changed location at each interval.

4. The system of claim 1, wherein the at least one item printing station is configured to print indicia with a changed footprint at each interval, and the at least one item handling station is configured to inspect each item for an indicium having the changed footprint at each interval.

5. The system of claim 1, wherein the at least one item printing station is configured to print indicia in at least one changed ink at each interval, and the at least one item handling station is configured to inspect each item for an indicium in the changed ink at each interval.

6. The system of claim 1, wherein the indicia each comprise a plurality of elements, ones of which are of different ink.

7. The system of claim 1, comprising a plurality of item printing stations.

8. The system of claim 1, comprising a plurality of item handling stations.

9. The system of claim 1, wherein the items comprise mail items, such as letters and parcels.

10. An item printing station for printing indicia on items, wherein the indicia are printed at least one of at one of a plurality of locations, with one of a plurality of footprints and in at least one of a plurality of inks as defined by a configuration signal, and the configuration signal is changed at intervals such that at least one of the location, the footprint and the at least one ink of the indicia printed on items is changed at each interval.

11. The printing station of claim 10, where configured to print indicia at a changed location at each interval.

12. The printing station of claim 10, where configured to print indicia with a changed footprint at each interval.

13. The printing station of claim 10, where configured to print indicia in at least one changed ink at each interval.

14. The printing station of claim 10, wherein the indicia each comprise a plurality of elements, ones of which are of different ink.

15. The printing station of claim 10, wherein the items comprise mail items, such as letters and parcels.

16. An item handling station for handling items having indicia printed thereon, wherein the handling station is configured to inspect each item for at least one of an indicium in a field at one of a plurality of locations, an indicium with one of a plurality of footprints and an indicium in at least one of a plurality of inks as defined by a configuration signal, where the configuration signal is changed at intervals such that at least one of the location of the field, the footprint and the at least one ink is changed at each interval, whereby items not having the at least one of an indicium in a field of defined location, an indicium with a defined footprint and an indicium in at least one defined ink as defined by the configuration signal at each interval is identified.

17. The handling station of claim 16, where configured to inspect each item for an indicium in a field of defined location at each interval.

18. The handling station of claim 16, where configured to inspect each item for an indicium of defined footprint at each interval.

19. The handling station of claim 16, where configured to inspect each item for an indicium in at least one defined ink at each interval.

20. The handling station of claim 16, wherein the indicia each comprise a plurality of elements, ones of which are of different ink.

21. The handling station of claim 16, wherein the items comprise mail items, such as letters and parcels.

22. A method of processing items each having an indicium printed thereon, the method comprising the steps of:
printing indicia on items, wherein the indicia are printed at least one of at one of a plurality of locations, with one of a plurality of footprints and in at least one of a plurality of inks as defined by a configuration signal; and
handling items having indicia printed thereon, wherein the item handling step comprises the step of:
inspecting each item for at least one of an indicium in a field of defined location, an indicium of defined footprint and an indicium in at least one defined ink as defined by the configuration signal;
wherein the configuration signal is changed at intervals such that at least one of the location, the footprint and the at least one ink of the indicia printed on items is changed at each interval and correspondingly at least one of the field of defined location, the defined footprint and the at least one defined ink is changed at each interval, whereby items not having the at least one of an indicium in the defined field, an indicium of defined footprint and an indicium in the at least one defined ink is identified.

23. The method of claim 22, wherein the indicia printing step comprises the step of:
printing indicia on items at a changed location at each interval; and
the item handling step comprises the step of:
inspecting each item for an indicium in a field of the changed location at each interval.

24. The method of claim 22, wherein the indicia printing step comprises the step of:
printing indicia on items with a changed footprint at each interval; and
the item handling step comprises the step of:
inspecting each item for an indicium having the changed footprint at each interval.

25. The method of claim 22, wherein the indicia printing step comprises the step of:
printing indicia on items in at least one changed ink at each interval; and
the item handling step comprises the step of:
inspecting each item for an indicium in the changed ink at each interval.

26. The method of claim 22, wherein the indicia each comprise a plurality of elements, ones of which are of different ink.

27. The method of claim 22, wherein the item handling step is performed at at least one location separate to the indicia printing step.

28. The method of claim 22, wherein the indicia printing step is performed at a plurality of locations.

29. The method of claim 22, wherein the item handling step is performed at a plurality of locations.

30. The method of claim 22, wherein the items comprise mail items, such as letters and parcels.

31. A method of printing indicia on items, comprising the steps of:
printing indicia on items at least one of at one of a plurality of locations, with one of a plurality of footprints and in at least one of a plurality of inks as defined by a configuration signal; and
changing the configuration signal at intervals such that at least one of the location, the footprint and the at least one ink of the indicia printed on items is changed at each interval.

32. The method of claim 31, wherein the indicia printing step comprises the step of:
printing indicia on items at a changed location at each interval.

33. The method of claim 31, wherein the indicia printing step comprises the step of:
printing indicia on items with a changed footprint at each interval.

34. The method of claim 31, wherein the indicia printing step comprises the step of:
printing indicia on items in at least one changed ink at each interval.

35. The method of claim 31, wherein the indicia each comprise a plurality of elements, ones of which are of different ink.

36. The method of claim 31, wherein the indicia printing step is performed at a plurality of locations.

37. The method of claim 31, wherein the items comprise mail items, such as letters and parcels.

38. A method of handling items having indicia printed thereon, comprising the steps of:
handling items having indicia printed thereon, wherein the item handling step comprises the step of:
inspecting each item for at least one of an indicium in a field at one of a plurality of locations, an indicium with one of a plurality of footprints and an indicium in at least one of a plurality of inks as defined by a configuration signal; and
changing the configuration signal at intervals such that at least one of the location of the field, the footprint and the at least one ink is changed at each interval, whereby items not having the at least one of an indicium in a field of defined location, an indicium with a defined footprint and an indicium in at least one defined ink as defined by the configuration signal at each interval is identified.

39. The method of claim 38, wherein the item handling step comprises the step of:
inspecting each item for an indicium in a field of defined location at each interval.

40. The method of claim 38, wherein the item handling step comprises the step of:
inspecting each item for an indicium of defined footprint at each interval.

41. The method of claim 38, wherein the item handling step comprises the step of:
inspecting each item for an indicium in at least one defined ink at each interval.

42. The method of claim 38, wherein the indicia each comprise a plurality of elements, ones of which are of different ink.

43. The method of claim 38, wherein the item handling step is performed at a plurality of locations.

44. The method of claim 38, wherein the items comprise mail items, such as letters and parcels.
